(19) United States
(12) Patent Application Publication
(10) Pub. No.: US 2026/0088680 A1
(43) Pub. Date: Mar. 26, 2026

(54) ELECTRIC UNIT

(71) Applicant: TOYOTA JIDOSHA KABUSHIKI KAISHA, Toyota-shi (JP)

(72) Inventor: Singo TOYAMA, Nisshin-shi (JP)

(73) Assignee: TOYOTA JIDOSHA KABUSHIKI KAISHA, Toyota-shi (JP)

(21) Appl. No.: 19/325,046

(22) Filed: Sep. 10, 2025

(30) Foreign Application Priority Data
Sep. 20, 2024 (JP) 2024-163994

(51) Int. Cl. H02K 5/22; H01R 9/24

(52) U.S. Cl. CPC H02K 5/225; H01R 9/2491

(57) ABSTRACT

An electric unit may include a housing including a service hole and a terminal block housed in the housing. The housing may include a rib extending across an opening of the service hole. The terminal block may include a first electrical connection structure and a second electrical connection structure of a different type from the first electrical connection structure. At least a portion of the first electrical connection structure may be located to be exposed to an outside through the opening of the service hole. At least a portion of the second electrical connection structure is located behind the rib.

### CROSS REFERENCE TO RELATED APPLICATION

This application claims priority to Japanese Patent Application No. 2024-163994 filed on September 20, 2024. The entire content of the priority application is incorporated herein by reference.

### TECHNICAL FIELD

The disclosure herein relates to an electric unit.

### BACKGROUND ART

Electric units include a housing that houses electric components. Electric units including a housing that houses mechanical components as well as electric components are particularly called electromechanical units, and such units have been developed. Japanese Patent No. 7248145 describes an example of electric unit of this type.

A terminal block is located in a housing to secure electrical connections with components housed in the housing. The terminal block is located to be exposed to the outside through an opening of a service hole formed in the housing. This allows a user to access the terminal block through the opening of the service hole after the components have been assembled in the housing. The user can thus perform electrical connection work at the terminal block through the opening of the service hole.

### SUMMARY

Multiple types of electrical connection structures, which correspond to multiple types of components housed in a housing, may be incorporated into a terminal block. These electrical connection structures include, but are not limited to, a connection structure that fastens conductor plates together with a fastener and a connection structure that connects between wire harnesses with a relay connector. The incorporation of such multiple types of electrical connection structures into a terminal block may increase the size of the terminal block. In order to prevent an increase in the housing size, there is a need for a technology to house a terminal block in a limited space within a housing. The disclosure herein provides a technology for suppressing an increase in the size of a housing that houses a terminal block.

An electric unit disclosed herein may comprise a housing including a service hole and a terminal block housed in the housing. The housing may comprise a rib extending across an opening of the service hole. The terminal block may comprise a first electrical connection structure and a second electrical connection structure of a different type from the first electrical connection structure. At least a portion of the first electrical connection structure may be located to be exposed to an outside through the opening of the service hole. At least a portion of the second electrical connection structure may be located behind the rib.

### BRIEF DESCRIPTION OF DRAWINGS

FIG. 1 is a cross-sectional view of an electromechanical unit 10.

FIG. 2 is a diagram illustrating a terminal block 40 visible through an opening of a service hole 14f.

FIG. 3 is a cross-sectional view corresponding to a line III-III in FIG. 1.

FIG. 4 is a cross-sectional view corresponding to a line IV-IV in FIG. 1.

### DETAILED DESCRIPTION

In one aspect of the present teachings, an electric unit may comprise a housing including a service hole and a terminal block housed in the housing. The housing may comprise a rib extending across an opening of the service hole. The terminal block may comprise a first electrical connection structure and a second electrical connection structure of a different type from the first electrical connection structure. At least a portion of the first electrical connection structure may be located to be exposed to an outside through the opening of the service hole. At least a portion of the second electrical connection structure may be located behind the rib. The first electrical connection structure may be, for example, a structure for which work for electrically connecting components needs to be performed through the opening of the service hole after the components have been assembled in the housing. The second electrical connection structure may be, for example, a structure for which work for electrically connecting components does not need to be performed through the opening of the service hole after the components have been assembled in the housing.

The housing of the above electric unit comprises the rib extending across the service hole to suppress a reduction in rigidity of the housing. The presence of the rib at the service hole may make it difficult for a user to access a space behind the rib through the opening of the service hole. However, in the electric unit described above, the electrical connection structure is disposed behind the rib that does not hinder electrical connection work despite being disposed behind the rib. This allows for an effective use of the space behind the rib located at the service hole, suppressing an increase in the size of the housing.

The opening of the service hole may extend along one direction when viewed in a direction perpendicular to an opening surface of the opening of the service hole. The rib may extend across the opening along a direction perpendicular to the one direction.

At least the portion of the second electrical connection structure may be located to overlap the rib when viewed in a direction perpendicular to an opening surface of the opening of the service hole.

The housing may further comprise a partition wall located between a first chamber and a second chamber. The terminal block may extend through the partition wall and be located in both of the first chamber and the second chamber.

The first electrical connection structure may electrically connect between a component located in the first chamber and a component located in the second chamber. The second electrical connection structure may electrically connect between a component located in the first chamber and a component located in the second chamber. A voltage delivered through the second electrical connection structure may be lower than a voltage delivered through the first electrical connection structure.

The first electrical connection structure may electrically connect between conductor plates by fastening the conductor plates with a fastener. The second electrical connection structure may electrically connect between wire harnesses by connecting the wire harnesses with a relay connector.

The electric unit may further comprise a motor housed in the housing, a sensor housed in the housing and configured to detect a state of the motor, a power control circuit housed in the housing, and a control board configured to control the power control circuit. The motor and the power control circuit may be electrically connected to each other via the first electrical connection structure. The sensor and the control board may be electrically connected to each other via the second electrical connection structure.

The second electrical connection structure may comprise a relay connector. The sensor may be electrically connected to the relay connector via a first wire harness. The control board may be electrically connected to the relay connector via a second wire harness.

The electric unit may further comprise a power control terminal housed in the housing and electrically connected to the power control circuit. The power control terminal may be fastened to the first electrical connection structure with a fastener. A fastened portion between the power control terminal and the first electrical connection structure may be located to be exposed to the outside through the opening of the service hole.

The housing may further comprise a partition wall located between a first chamber and a second chamber. The terminal block may extend through the partition wall and be located in both of the first chamber and the second chamber.

The motor and the sensor may be housed in the first chamber of the housing. The power control circuit may be housed in the second chamber of the housing.

The first electrical connection structure may be electrically connected to the power control circuit in the second chamber.

The electric unit may further comprise a power control terminal housed in the housing and electrically connected to the power control circuit. The first electrical connection structure may comprise a conductor plate that extends in both of the first chamber and the second chamber and electrically connected to the motor. The power control terminal may be fastened to the conductor plate of the first electrical connection structure with a fastener. A fastened portion between the power control terminal and the conductor plate of the first electrical connection structure may be located to be exposed to the outside through the opening of the service hole.

The second electrical connection structure may be electrically connected to the sensor in the first chamber and electrically connected to the control board in the second chamber.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved electric units, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

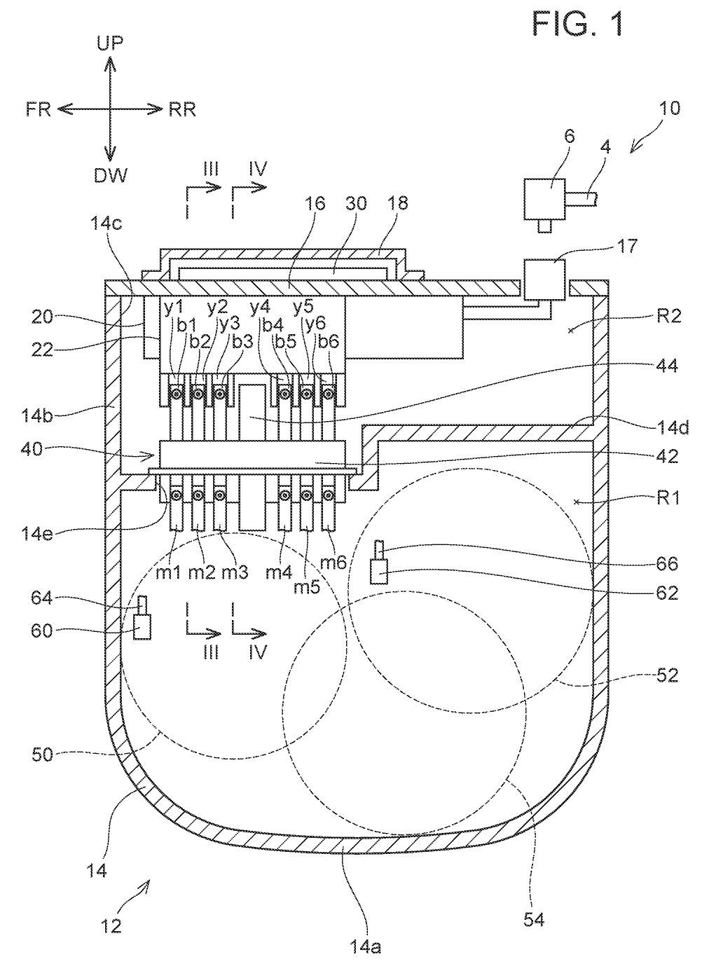

Referring to FIGS. 1 to 4, an electromechanical unit 10, which is an example of electric unit, is described. The electromechanical unit 10 may be mounted, for example, in a front compartment of an electric vehicle, although this need not always be the case. The electric vehicle herein may be a hybrid car that operates using an engine and a motor, an electric car that operates using a motor, or a fuel car.

In the drawings, directions of the electromechanical unit 10 are defined as directions when the electromechanical unit 10 is mounted in the electric vehicle, that is, based on directions of the electric vehicle. A direction FR indicates the front direction of front-rear direction of the electric vehicle and a direction RR indicates the rear direction of the front-rear direction of the electric vehicle. A direction LH indicates the left direction of right-left direction of the electric vehicle and a direction RH indicates the right direction of the right-left direction of the electric vehicle. A direction UP indicates the up direction of up-down direction of the electric vehicle and a direction DW indicates the down direction of the up-down direction of the electric vehicle.

As shown in FIG. 1, the electromechanical unit 10 comprises a housing 12, a power control circuit 20, a control board 30, a terminal block 40, a plurality of motors 50, 52, a gear mechanism 54, and a plurality of sensors 60, 62.

The housing 12 is an enclosure member and comprises a housing body 14 and a cover plate 16. The housing body 14 comprises a bottom wall 14a and a surrounding wall 14b extending upward from the perimeter edge of the bottom wall 14a. An opening 14c defined by the upper end of the surrounding wall 14b is located in an upper portion of the housing body 14. The opening 14c of the housing body 14 is closed by the cover plate 16. The cover plate 16 is detachably attachable to the opening 14c of the housing body 14. The power control circuit 20 is fixed to the lower surface of the cover plate 16, and the control board 30 is fixed to the upper surface of the cover plate 16. The control board 30 is covered by a protection cover 18 located on the cover plate 16. A power socket 17 is located at a portion of the cover plate 16 that is not covered by the protection cover 18. The power socket 17 is configured to allow a power connector 6 of a power cable 4 to connect thereto. Thus, DC power from a power supply mounted in the electric vehicle can be supplied to the power control circuit 20. The housing body 14, the cover plate 16, and the protection cover 18 may be constituted of a material such as aluminum, although this need not always be the case.

The housing 12 further comprises a partition wall 14d partitioning the internal space of the housing 12 in the up-down direction. A portion of the internal space of the housing 12 that is below the partition wall 14d is defined as a first chamber R1, and a portion of the internal space of the housing 12 that is above the partition wall 14d is defined as a second chamber R2.

The plurality of motors 50, 52, the gear mechanism 54, and the plurality of sensors 60, 62 are located in the first chamber R1 of the housing 12. The plurality of motors 50, 52 are traction motors configured to drive the wheels of the electric vehicle. The plurality of motors 50, 52 comprises a first motor 50 and a second motor 52. The gear mechanism 54 comprises, for example, a planetary gear mechanism, a reduction gear mechanism, and a differential gear mechanism. Power of the motors 50 and 52 is output to the wheels of the electric vehicle via the gear mechanism 54.

The first motor 50 is a three-phase alternating-current motor and comprises three motor terminals m1 to m3 corresponding to the U, V, W phases. Similarly, the second motor 52 is also a three-phase alternating-current motor and comprises three motor terminals m4 to m6 corresponding to the U, V, W phases. These motor terminals m1 to m6 are elongated conductor plates and may be constituted of conductive material(s) such as metal(s), although this need not always be the case. The plurality of motor terminals m1 to m6 is housed in the first chamber R1 of the housing 12. The motor terminals m1 to m6 each extend upward and are separated from each other along the front-rear direction of the electric vehicle. The interval between the motor terminal m3 and the motor terminal m4 is wider than the intervals between the other motor terminals.

The plurality of sensors 60, 62 comprises a first sensor 60 and a second sensor 62. The first sensor 60 is mounted on the first motor 50 and configured to detect the state of the first motor 50. The first sensor 60 may be, for example, at least one of a rotation angle sensor configured to detect the rotation angle of the first motor 50 and a temperature sensor configured to detect the temperature of the first motor 50, although this need not always be the case. As will be described later, a wire harness 64 connected to the first sensor 60 is connected to a relay connector 44 of the terminal block 40. The second sensor 62 is mounted on the second motor 52 and configured to detect the state of the second motor 52. The second sensor 62 may be, for example, at least one of a rotation angle sensor configured to detect the rotation angle of the second motor 52 and a temperature sensor configured to detect the temperature of the second motor 52, although this need not always be the case. As will be described later, a wire harness 66 connected to the second sensor 62 is connected to the relay connector 44 of the terminal block 40.

The power control circuit 20 is located in the second chamber R2 of the housing 12. The power control circuit 20 comprises a step-up converter and an inverter and is configured to boost the DC power supplied from the power supply and convert it to AC power. A power control terminal block 22 is located adjacent to the power control circuit 20. The power control terminal block 22 comprises power control terminals y1 to y6 to output the AC power generated by the power control circuit 20. These power control terminals y1 to y6 are elongated conductor plates and may be constituted of conductive material(s) such as metal(s), although this need not always be the case. Three power control terminals y1 to y3 corresponding to the U, V, W phases are power control terminals to output the AC power to the first motor 50. Three power control terminals y4 to y6 corresponding to the U, V, W phases are power control terminals to output the AC power to the second motor 52. The plurality of power control terminals y1 to y6 is housed in the second chamber R2 of the housing 12. The power control terminals y1 to y6 each extend downward and are separated from each other along the front-rear direction of the electric vehicle. The interval between the power control terminal y3 and the power control terminal y4 is wider than the intervals between the other power control terminals.

The control board 30 located on the upper surface of the cover plate 16 comprises a microcomputer that comprises, for example, a CPU, a RAM, a ROM, an input/output interface, etc. The control board 30 controls the operation of the power control circuit 20 by the CPU processing signals according to program(s) stored in the ROM in a work area on the RAM. The control board 30 controls the operation of the power control circuit 20 based on detection signals from various sensors including the plurality of sensors 60, 62.

A through hole 14e is formed in the partition wall 14d of the housing 12 and the through hole 14e communicates the first chamber R1 with the second chamber R2. The terminal block 40 is positioned to close the through hole 14e of the partition wall 14d and is located in both of the first chamber R1 and the second chamber R2.

The terminal block 40 comprises a terminal block body 42, a plurality of relay busbars b1 to b6, and a relay connector 44. The terminal block body 42 has a substantially box shape and may be constituted of an insulating material such as a resin, although this need not always be the case. The relay busbars b1 to b6 are elongated conductive plates fixed to the terminal block body 42 and may be constituted of conductive material(s) such as metal(s), although this need not always be the case. Each of the relay busbars b1 to b6 may be formed integrally with corresponding one of the motor terminals m1 to m6. That is, each of the relay busbars b1 to b6 may form an end portion of corresponding one of the motor terminals. For example, the relay busbar b1 may form an end portion of the motor terminal m1. The relay busbars b1 to b6 extend in the up-down direction of the electric vehicle and are separated from each other along the front-rear direction of the electric vehicle. The interval between the relay busbar b3 and the relay busbar b4 is wider than the intervals between the other relay busbars, and the relay connector 44 is located between the relay busbar b3 and the relay busbar b4.

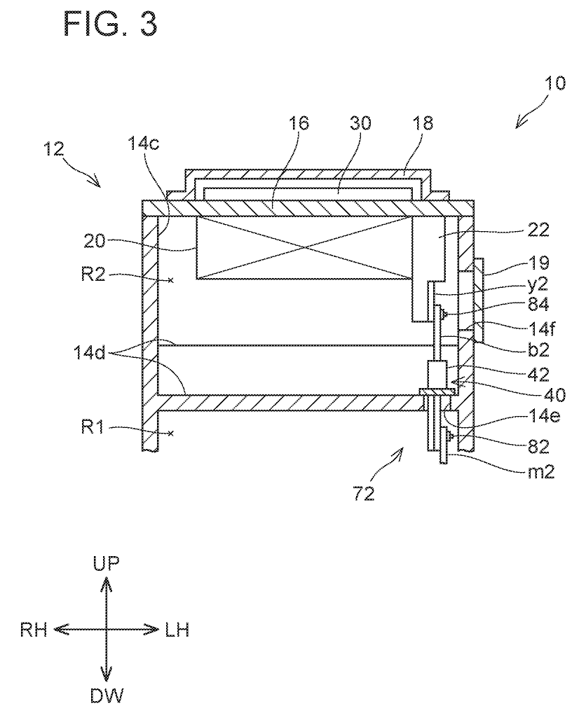

As shown in FIGS. 1 and 3, each of the relay busbars b1 to b6 extends in both of the first chamber R1 and the second chamber R2. That is, one end of each of the relay busbars b1 to b6 is located in the first chamber R1 and the opposite end of each of the relay busbars b1 to b6 is located in the second chamber R2. Each of the relay busbars b1 to b6 is fastened to corresponding one of the motor terminals m1 to m6 with a fastener 82 (e.g., a bolt and a nut) in the first chamber R1. Thus, the relay busbars b1 to b6 are electrically connected to the corresponding motor terminals. Each of the relay busbars b1 to b6 is fastened to corresponding one of the power control terminals y1 to y6 with a fastener 84 (e.g., a bolt and a nut) in the second chamber R2. Thus, the relay busbars b1 to b6 are electrically connected to the corresponding power control terminals. In this embodiment, among electrical connection structures of the terminal block 40, an electrical connection structure that electrically connects the motor terminals m1 to m6, the relay busbars b1 to b6, and the power control terminals y1 to y6 to one another is referred to as a “first electrical connection structure 72”. That is, the first electrical connection structure 72 electrically connects between the conductor plates by fastening the conductor plates with the fasteners. Thus, the first electrical connection structure 72 can deliver a high voltage required to drive the first motor 50 and the second motor 52 from the power control circuit 20 to the first motor 50 and the second motor 52.

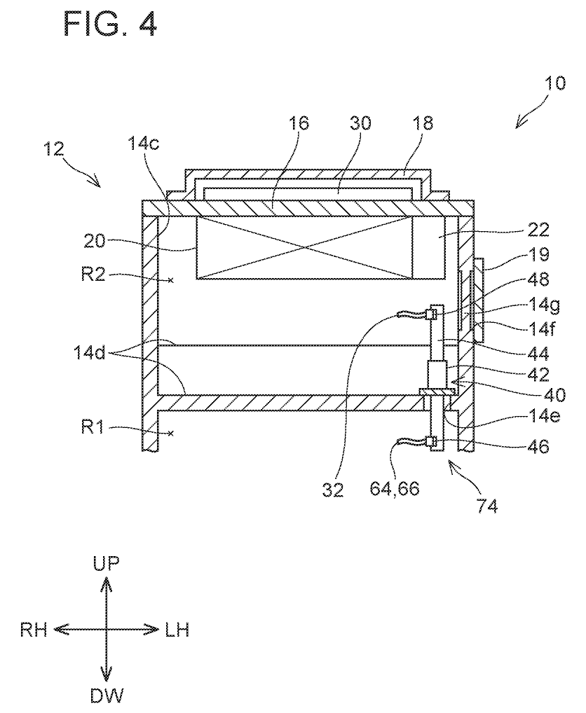

As shown in FIGS. 1 and 4, the relay connector 44 is formed integrally with the terminal block body 42 of the terminal block 40. The relay connector 44 extends in both of the first chamber R1 and the second chamber R2 and comprises a plurality of first sockets 46 located in the first chamber R1 and a second socket 48 located in the second chamber R2. FIG. 4 depicts only one socket of the plurality of sockets 46 for simplicity of the drawing. Both the plurality of first sockets 46 and the second socket 48 may be located in either the first chamber R1 or the second chamber R2. A connector at an end of a wire harness 64 connected to the first sensor 60 and a connector at an end of a wire harness 66 connected to the second sensor 62 are connected to the plurality of first sockets 46 of the relay connector 44. A connector at an end of the wire harness 32 is connected to the second socket 48 of the relay connector 44. The wire harness 32 extends in the first chamber R1 and is connected to the control board 30. Thus, the relay connector 44 relays the wire harnesses 64, 66 extending from the plurality of sensors 60, 62 to the wire harness 32 extending from the control board 30 to transmit detection signals detected at the plurality of sensors 60, 62 to the control board 30. In this embodiment, among electrical connection structures of the terminal block 40, an electrical connection structure that electrically connects the wire harnesses 64, 66 extending from the plurality of sensors 60, 62, the relay connector 44, and the wire harness 32 extending from the control board 30 to one another is referred to as a “second electrical connection structure 74”. That is, the second electrical connection structure 74 connects between the wire harnesses via the relay connector. Thus, a voltage delivered via the second electrical connection structure 74 is lower than the voltage delivered via the first electrical connection structure 72.

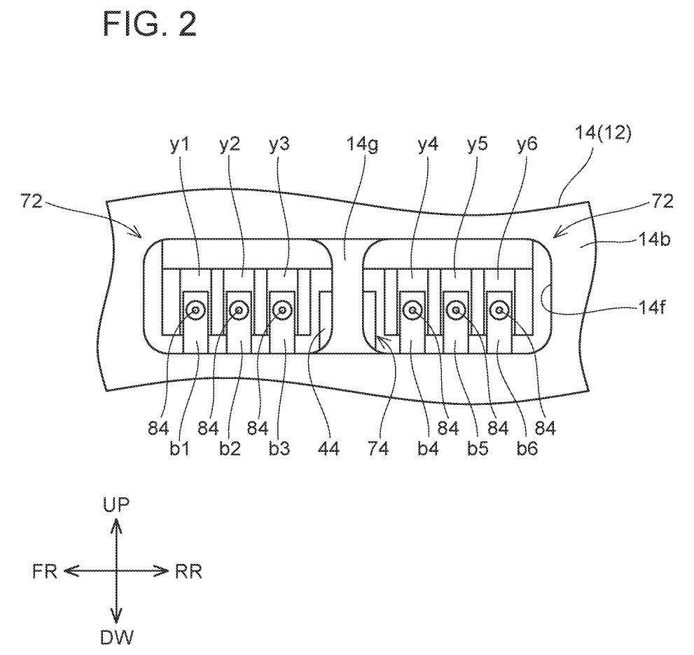

As shown in FIG. 2, the housing 12 comprises a service hole 14f in the second chamber R2, and the service hole 14f is elongated in the front-rear direction of the electric vehicle. That is, the opening of the service hole 14f has a substantially rectangular shape. The housing 12 further comprises a rib 14g extending across the service hole 14f in the up-down direction of the electric vehicle. That is, the rib 14g extends in the up-down direction of the electric vehicle to connect the pair of long sides defining the opening of the service hole 14f. The presence of the rib 14g at the service hole 14f suppresses a reduction in the rigidity of the housing 12 which may be caused by the formation of the service hole 14f. The geometry of the rib 14g, including the width of the rib 14g in the front-rear direction of the electric vehicle and the thickness of the rib 14g in the right-left direction of the electric vehicle, may be varied. The service hole 14f is covered by a service hole cover 19 covering the entire opening of the service hole 14f (see FIGS. 3 and 4). The service hole cover 19 is attached to the service hole 14f in a detachable manner or such that the service hole cover 19 can open and close the opening of the service hole 14f.

As shown in FIG. 2, a portion of the first electrical connection structure 72 (i.e., portions where the power control terminals y1 to y6 are fastened to the relay busbars b1 to b6 with the fasteners 84) is positioned to be exposed to the outside through the opening of the service hole 14f. In other words, when viewed in a direction perpendicular to the opening surface of the opening of the service hole 14f, the portions where the power control terminals y1 to y6 are fastened to the relay busbars b1 to b6 with the fasteners 84 do not overlap the rib 14g. Thus, after having assembled various components in the housing 12, the user can access the first electric connection structure 72 of the terminal block 40 through the opening of the service hole 14f to perform work of fastening the plurality of power control terminals y1 to y6 to the plurality of relay busbars b1 to b6 with the fasteners 84.

As shown in FIG. 2, a portion of the second electrical connection structure 74 (i.e., the relay connector 44) is positioned behind the rib 14g extending across the service hole 14f. In other words, when viewed in the direction perpendicular to the opening surface of the opening of the service hole 14f, the relay connector 44 is positioned to overlap the rib 14g. The presence of the rib 14g at the service hole 14f may make it difficult for the user to access a space behind the rib 14g through the opening of the service hole 14f. However, the wire harnesses 64, 66 extending from the sensors 60, 62 and the wire harness 32 extending from the control board 30 are flexible and sufficiently long. Thus, the wire harnesses 32, 64, 66 can be connected to the relay connector 44 before various components are assembled in the housing 12. That is, work of connecting the wire harnesses 32, 64, 66 to the relay connector 44 does not need to be performed through the opening of the service hole 14f.

In the electromechanical unit 10 described above, the relay connector 44 for which electrical connection work does not need to be performed through the opening of the service hole 14f is positioned behind the rib 14g. This allows for effective use of the space behind the rib 14g located at the service hole 14f, suppressing an increase in the size of the housing 12.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. An electric unit comprising:
a housing including a service hole; and
a terminal block housed in the housing,
wherein
the housing comprises a rib extending across an opening of the service hole,
the terminal block comprises:
a first electrical connection structure; and
a second electrical connection structure of a different type from the first electrical connection structure,
at least a portion of the first electrical connection structure is located to be exposed to an outside through the opening of the service hole, and
at least a portion of the second electrical connection structure is located behind the rib.

2. The electric unit according to claim 1, wherein
the opening of the service hole extends along one direction when viewed in a direction perpendicular to an opening surface of the opening of the service hole, and
the rib extends across the opening along a direction perpendicular to the one direction.

3. The electric unit according to claim 1, wherein
at least the portion of the second electrical connection structure is located to overlap the rib when viewed in a direction perpendicular to an opening surface of the opening of the service hole.

4. The electric unit according to claim 1, wherein
the housing further comprises a partition wall located between a first chamber and a second chamber, and
the terminal block extends through the partition wall and is located in both of the first chamber and the second chamber.

5. The electric unit according to claim 4, wherein
the first electrical connection structure electrically connects between a component located in the first chamber and a component located in the second chamber,
the second electrical connection structure electrically connects between a component located in the first chamber and a component located in the second chamber, and
a voltage delivered through the second electrical connection structure is lower than a voltage delivered through the first electrical connection structure.

6. The electric unit according to claim 5, wherein
the first electrical connection structure electrically connects between conductor plates by fastening the conductor plates with a fastener, and
the second electrical connection structure electrically connects between wire harnesses by connecting the wire harnesses with a relay connector.

7. The electric unit according to claim 1, further comprising:
a motor housed in the housing;
a sensor housed in the housing and configured to detect a state of the motor;
a power control circuit housed in the housing; and
a control board configured to control the power control circuit,
wherein the motor and the power control circuit are electrically connected to each other via the first electrical connection structure, and
the sensor and the control board are electrically connected to each other via the second electrical connection structure.

8. The electric unit according to claim 7, wherein
the second electrical connection structure comprises a relay connector,
the sensor is electrically connected to the relay connector via a first wire harness, and
the control board is electrically connected to the relay connector via a second wire harness.

9. The electric unit according to claim 7, further comprising:
a power control terminal housed in the housing and electrically connected to the power control circuit,
wherein the power control terminal is fastened to the first electrical connection structure with a fastener, and
a fastened portion between the power control terminal and the first electrical connection structure is located to be exposed to the outside through the opening of the service hole.

10. The electric unit according to claim 7, wherein
the housing further comprises a partition wall located between a first chamber and a second chamber, and
the terminal block extends through the partition wall and is located in both of the first chamber and the second chamber.

11. The electric unit according to claim 10, wherein
the motor and the sensor are housed in the first chamber of the housing, and
the power control circuit is housed in the second chamber of the housing.

12. The electric unit according to claim 11, wherein
the first electrical connection structure is electrically connected to the power control circuit in the second chamber.

13. The electric unit according to claim 12, further comprising:
a power control terminal housed in the housing and electrically connected to the power control circuit,
wherein the first electrical connection structure comprises a conductor plate that extends in both of the first chamber and the second chamber and electrically connected to the motor,
the power control terminal is fastened to the conductor plate of the first electrical connection structure with a fastener, and
a fastened portion between the power control terminal and the conductor plate of the first electrical connection structure is located to be exposed to the outside through the opening of the service hole.

14. The electric unit according to claim 11, wherein
the second electrical connection structure is electrically connected to the sensor in the first chamber and electrically connected to the control board in the second chamber.
